(19) United States
(12) Patent Application Publication
(10) Pub. No.: US 2024/0338789 A1
(43) Pub. Date: Oct. 10, 2024

(54) CONTROL OF INPUT DIMENSIONS FOR COMPUTER VISION MODEL TRAINING

(71) Applicant: Intel Corporation, Santa Clara, CA (US)

(72) Inventors: Songki Choi, Seoul (KR); Eunwoo Shin, Seoul (KR)

(21) Appl. No.: 18/747,926

(22) Filed: Jun. 19, 2024

(51) Int. Cl. G06T 3/40; G06T 7/62

(52) U.S. Cl. CPC G06T 3/40; G06T 7/62

(57) ABSTRACT

Example apparatus disclosed herein determine an initial spatial input size for training a computer vision model, the initial spatial input size based on sizes of input training images, apply an adjustment to the initial spatial input size to determine an adjusted spatial input size, the adjustment based on sizes of objects in the input training images, and map the adjusted spatial input size to one of a set of available spatial input sizes to determine a final spatial input size for training the computer vision model. Some disclosed apparatus evaluates a linear model to determine a final batch size for training the computer vision model, the linear model based on first and second simulations of training the computer vision model, the first simulation based on the final spatial input size and a first batch size, the second simulation based on the final spatial input size and a second batch size.

### BACKGROUND

Computer vision models include neural networks trained to process and interpret visual data. Such neural network models can be trained based on a training dataset including images and/or videos to identify patterns, objects, features, etc., within images or videos. Furthermore, such neural networks can be trained to perform more complex tasks such as object detection, image classification, facial recognition and/or any other visual identification task(s).

### BRIEF DESCRIPTION OF THE DRAWINGS

FIG. 1 is a block diagram of an example environment in which example input dimension control circuitry operates to automatically control input dimensions of a neural network training pipeline based on an input dataset.

FIG. 2 is a block diagram of an example implementation of spatial size adaptation circuitry included in the input dimension control circuitry of FIG. 1.

FIG. 3 illustrates example operation of example spatial size analysis circuitry included in the spatial size adaptation circuitry of FIG. 2.

FIG. 4 illustrates example operation of example object size analysis circuitry included in the spatial size adaptation circuitry of FIG. 2.

FIGS. 5-6 illustrate example operation of example batch size adaptation circuitry included in the input dimension control circuitry of FIG. 1.

FIG. 7 illustrates example operation of example resized image cache circuitry included in the input dimension control circuitry of FIG. 1.

FIGS. 8-10 are flowcharts representative of example machine readable instructions and/or example operations that may be executed, instantiated, and/or performed by example programmable circuitry to implement the input dimension control circuitry of FIGS. 1 and/or 2.

FIG. 11 is a block diagram of an example processing platform including programmable circuitry structured to execute, instantiate, and/or perform the example machine readable instructions and/or perform the example operations of FIGS. 8-10 to implement the input dimension control circuitry 105 input dimension control circuitry of FIGS. 1 and/or 2.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine readable instructions of FIGS. 8-10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Computer vision models include neural networks trained to process and interpret visual data to perform various tasks, such as object detection, image classification, facial recognition, etc. Neural network models may have input dimensions that can be customized to enable the models to process and extract relevant information from input images or videos for specific use cases. Input dimensions include spatial dimensions (e.g., height and width of the input data or images) and batch sizes. For example, for image-based computer vision models, input dimensions can include batch size (N), channels (C), height (H) and width (W). For video-based computer vision models, input dimensions can include batch size, frames, channels, height, and width.

However, prior computer vision model training systems typically train such neural networks based on pre-defined, static input dimensions. Utilizing pre-defined, static input dimensions can waste compute resources if the static input dimensions used for training exceed the input dimensions that would yield satisfactory performance during model operation. Furthermore, manual efforts to tune the input dimension parameters for training computer vision models for new use cases may involve substantial trial-and-error effort. Conversely, for low-end hardware platforms, there is a potential risk of resource shortages, such as graphics processing unit (GPU) out-of-memory (OOM) errors, if the pre-defined, static input dimensions exceed the capabilities of the low-end hardware platform.

In contrast, examples disclosed herein automatically adapt the input dimensions for computer vision model training based on the training dataset and system resources to customize the training to the particular computer vision use case. For example, input dimension control circuitry disclosed herein analyzes the input dimensions of the input images and adjusts the spatial input size or spatial resolution. In some examples, the input dimension control circuitry disclosed herein adjusts training batch size based on the training dataset and available GPU memory in the training pipeline. In some examples, the input dimension control circuitry caches resized and/or preprocessed input training images to avoid re-processing the same input image, thereby reducing compute overhead. These operations are described in further detail below.

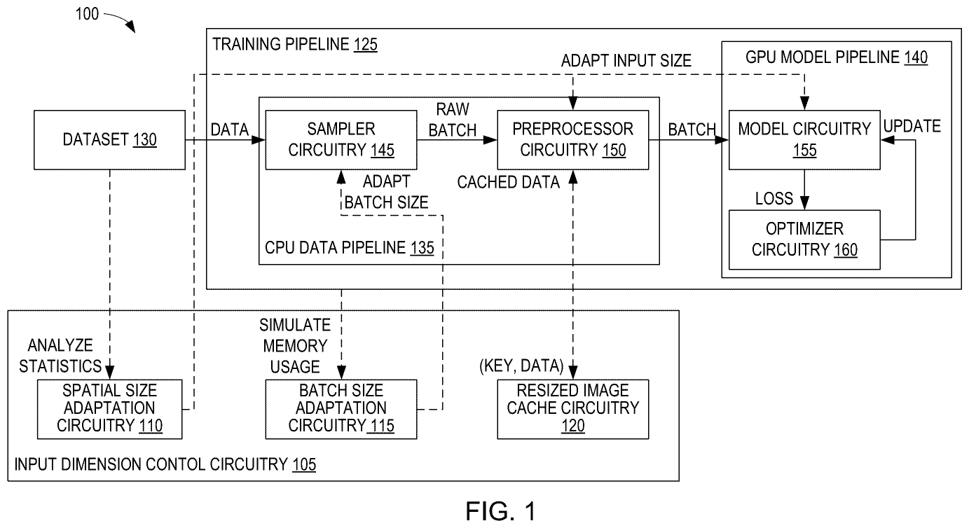

FIG. 1 is a block diagram of an example environment 100 in which example input dimension control circuitry 105 operates to automatically control input dimensions of a neural network model in the context of computer vision. The input dimension control circuitry 105 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the input dimension control circuitry 105 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The example input dimension control circuitry 105 includes example spatial size adaptation circuitry 110, example batch size adaptation circuitry 115, and example resized image cache circuitry 120. The example environment 100 integrates the input dimension control circuitry 105 with an example deep learning model training pipeline 125 that trains a computer vision model based on an example training dataset 130. For example, the deep learning model training pipeline 125 includes an example central processing unit (CPU) data pipeline 135 and an example GPU model pipeline 140. The CPU data pipeline 135 includes example sampler circuitry 145 and example preprocessor circuitry 150 to preprocess the training dataset 130 before being used for model training. The GPU model pipeline 140 includes example model circuitry 155 implementing the computer vision model to be trained, and example optimizer circuitry 160 to train the computer vision model based on the preprocessed training data.

In the illustrated example, the GPU model pipeline 140 implements one or more computer vision models and manages the training of those model(s). The GPU model pipeline 140 may be implemented by one or more GPUs. For example, the GPU model pipeline 140 of FIG. 1 includes example model circuitry 155 and example optimizer circuitry 160 implemented by one or more GPUs. The model circuitry 155 implements the computer vision model. For example, the model circuitry 155 implements a neural network having multiple layers, activation functions and connections. The model circuitry 155 determines predictions on the input data, such as class labels, bounding boxes, segmentation masks and/or other relevant information depending on the specific computer vision task. The model circuitry 155 also calculates loss or error between the predicted output and ground truth labels provided by the training dataset 130. Depending on the output of the model circuitry 155, the optimizer circuitry 160 updates the parameters of the model circuitry 155 based on one or more loss functions. In some examples, the optimizer circuitry 160 performs a forward and/or backward optimization process. In the illustrated example, the model circuitry 155 has configurable input size that adapts its internal computations based on the spatial size of the input images and the batch size of the input training images used during training.

In the illustrated example, the CPU data pipeline 135 loads, preprocesses and feeds the training dataset 130 to the GPU model pipeline 140. The CPU data pipeline 135 may be implemented by one or more CPUs. For example, the CPU data pipeline 135 of the illustrated example includes example sampler circuitry 145 and example preprocessor circuitry 150 implemented by one or more CPUs. The sampler circuitry 145 samples the training dataset 130, which includes input images, and creates raw batches from the training dataset 130 based on the batch size configuration provided by the batch size adaptation circuitry 115. The preprocessor circuitry 150 also preprocesses the raw batches by resizing the input images based on the spatial input size configuration set by the spatial size adaptation circuitry 110. The preprocessor circuitry 150 feeds the resized images to the model circuitry 155. The preprocessor circuitry 150 also sends the resized images to the resized image cache circuitry 120 to be cached with respective identifiers. Caching the resized images reduces computation and processing time in the training process because the preprocessed image is stored and readily accessible. Caching resized images ensures that the same resized images is used consistently across multiple epochs or iterations during training and the training dataset does not need to be preprocessed again for every training cycle. Furthermore, the resized images use less memory to store compared to their original input images.

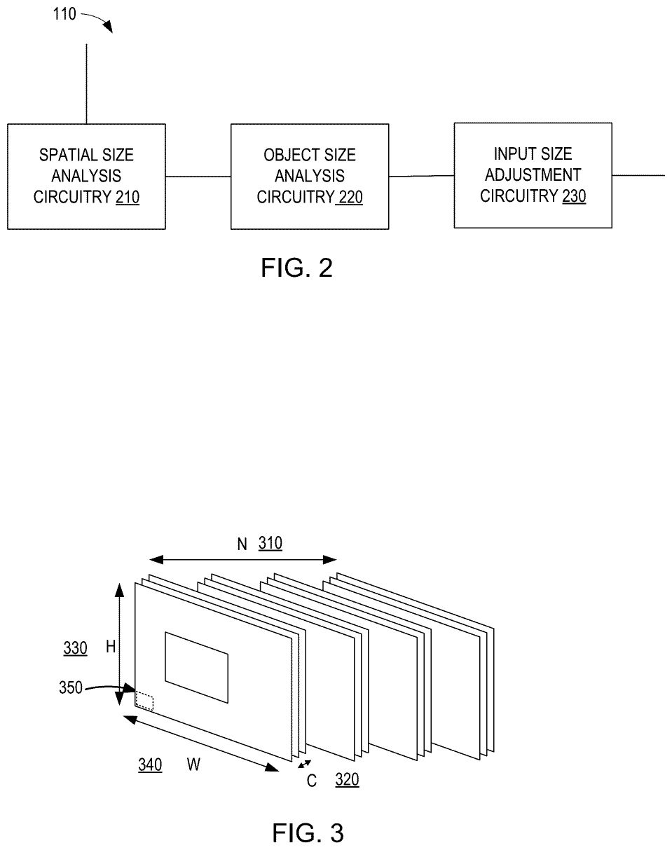

The example input dimension control circuitry 105 analyzes the training dataset 130 and configures the input dimensions used by the deep learning model training pipeline 125. For example, the spatial size adaptation circuitry 110 configures the preprocessor circuitry 150 and model circuitry 155 to adapt the spatial input size to be used to train the computer vision model implemented by the model circuitry 155. In some examples, the spatial input size is the height and width of the input images to be processed by the deep learning model training pipeline 125. The spatial input size is used by the preprocessor circuitry 150 to preprocess the input image based on the spatial input size determined by the spatial size adaptation circuitry 110. As disclosed in further detail below, the spatial size adaptation circuitry 110 adapts the spatial input size based on sizes of training images in the training dataset 130 and the sizes of objects depicted in the training images. FIG. 2 provides an example implementation of the spatial size adaptation circuitry 110.

FIG. 2 is a block diagram of an example implementation of the spatial size adaptation circuitry 110 included in the input dimension control circuitry of FIG. 1 to automatically control input dimensions of a computer vision model based on an input training dataset. The spatial size adaptation circuitry 110 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the size adaptation circuitry 110 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The spatial size adaptation circuitry 110 includes example spatial size analysis circuitry 210, example object size analysis circuitry 220, and example input size adjustment circuitry 230. The spatial size adaptation circuitry 110 determines the spatial resolution to be used by the computer vision training model based on the training dataset.

In the illustrated example of FIG. 2, the spatial size analysis circuitry 210 determines an initial input size to be used to train a computer vision model. The initial spatial input size is determined based on the size of the input training images in the training dataset 130 (see FIG. 1). In some examples, the spatial size analysis circuitry 210 determines the initial spatial input size based on an average size of the input training images. In some examples, the spatial size analysis circuitry 210 determines the initial spatial input size is based on a standard deviation of the sizes of the input training images, a maximum size of the input training images, a minimum size of the input training images, or any combination thereof.

For example, to reduce the impact of outliers, such as extremely large images or a few very small objects in the dataset 130, in some examples the spatial size analysis circuitry 210 limits the minimum or maximum size of the initial spatial input size to the range of [mean−(3*standard deviation), mean+(3*standard deviation)] (e.g., where the constant value of “3” can be replaced with any appropriate value). In image-based computer vision tasks such as image classification, or semantic segmentation, the spatial size analysis circuitry 210 sets the computer vision model initial spatial input size as “robust_max_image_size” to include most of the image sizes in the dataset 130. The “robust_max_image_size” is defined by the formula “min (max_image_size, avr_image_size+3*std_image_size)” (e.g., where the constant value of “3” can be replaced with any appropriate value). The “robust_max_image_size” determines the maximum allowable initial spatial input size based on the average image size and the standard deviation of the image size. The “avr_image_size” is the mean size of the images in the dataset 130. The “std_image_size” is the standard deviation of the image sizes in the dataset 130, indicating the variability or spread of the image sizes around the mean. The “max_image_size” is the maximum allowable image size that is set as a limit. The “min ( . . . )” function ensures that the final computed maximum input image size does not exceed either the predefined maximum size or the calculated size based on the average and standard deviation.

The preceding approach is a conservative strategy used by the spatial size analysis circuitry 210 to preserve the final model accuracy. However, in some examples, the spatial size analysis circuitry 210 uses “avr_image_size” as the initial spatial input size for computational efficiency with slight potential loss of accuracy for a few large images due to the loss of information by down-scaling. Down-scaling involves reducing the dimensions or resolution of the larger images to fit the initial spatial input size. To reduce the analysis overhead, the spatial size analysis circuitry 210 samples a limited number of sub-datasets to determine the initial spatial input size.

Example pseudocode which may be used by the spatial size analysis circuitry 210 to determine the initial spatial input size using the algorithm described above is illustrated in Table 1.

```
TABLE 1 [symbol]
[Pseudo code] Image size analysis
image_sizes = [ ]
for data in dataset:
  image = data.image
  image_sizes.append(sqrt(image.width * image.height)) [symbol]
Typical large image size
max_image_size = max(image_sizes)
avr_image_size = mean(image_sizes)
std_image_size = std(image_sizes) [symbol]  standard deviation
robust_max_image_size = min(max_image_size, avr_image_size +
3*std_image_size) [symbol]
Set base input size
input size = robust max image size [symbol]
indicates data missing or illegible when filed
```

FIG. 3 illustrates example operation of example spatial size analysis circuitry 210 included in the spatial size adaptation circuitry of FIG. 2. The example training dataset 130 includes training images having dimensions of height 330 and width 340. The spatial size analysis circuitry 210 configures the spatial input dimensions adaptively according to the given training dataset 130. The training input dimensions can include batch size (N) 310, channels (C) 320, height (H) 330 and width (W) 340 to be used by the training model. The spatial size analysis circuitry 210 determines the initial spatial input dimensions (e.g., height and width) based on the height 330 and width 340 dimensions of the training images in the training dataset 130. The computer vision model training efficiency is enhanced without loss of accuracy due to the right spatial resolution selected by the spatial size analysis circuitry 210.

Returning to FIG. 2, in addition to the image sizes, object annotations in the datasets of instance-based computer vision tasks, such as object detection and instance segmentation, can also be used to determine the spatial input size. In the illustrated example, the object size analysis circuitry 220 adjusts the initial spatial input size based on object sizes in the training images of the training dataset 130 to determine an adjusted spatial input size.

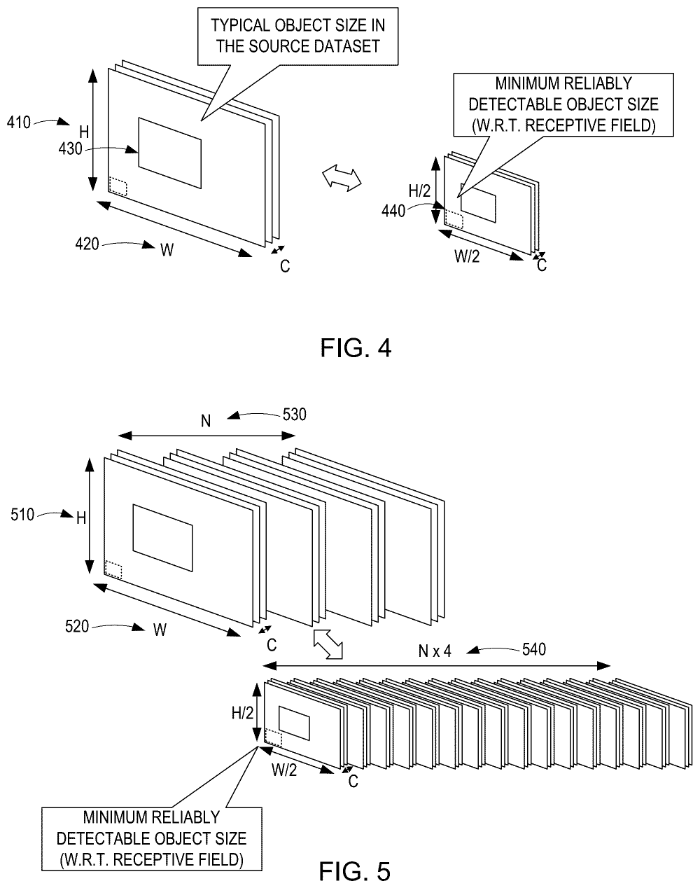

In some examples, the object size analysis circuitry 220 reduces the spatial input size to yield image resolutions that still enable detection of objects in an image by a computer vision task. For example, the object size analysis circuitry 220 evaluates the sizes of object represented in the training images in the dataset to determine whether the spatial input size should be adjusted (e.g., reduced or enlarged) to ensure accurate object detection. In the illustrated example of FIG. 4, images in the training dataset 130 have a spatial size including an example height, H, 410 and example width, W, 420. However, a computer vision model may not need to be trained with this high spatial resolution (e.g., H and W) to still enable reliable object detection. In the illustrated example, the object size analysis circuitry 220 detects a typical object size in the source training dataset and adjusts (e.g., reduces) the initial spatial input size to an adjusted spatial input size that still enables detection of objects.

For example, the object size analysis circuitry 220 may detect a typical object size in the training dataset as object 430. Convolution neural network model architectures typically have detectable or recognizable object size requirements. In the illustrated example of FIG. 4, a minimum reliably detectable object size 440 is depicted. So, given an input image with a height 410 of H and width 420 of W, and the minimum reliably detectable object size 440, the object size analysis circuitry 220 can adapt the spatial input dimension to an adjusted height (e.g., H/2 in FIG. 4) and an adjusted width (e.g., W/2 in FIG. 4) based on the object size. The object 430 can still be reliably detected with a reduced spatial resolution (e.g., height and width), but this spatial resolution reduction increases computational speed (e.g., by two-fold in the example of FIG. 4).

The minimum reliably detectable object size 440 in the image resolution depicts the receptive field of a neural network model, which is the area of an image that a neuron in a convolutional neural network can see. Generally, objects with a size of 32×32 to 64×64 pixels are able to be detected well in practice. The theoretical receptive field sizes can be different for different neural network architectures. For example, if the theoretical receptive field sizes for a neural network is 64×64 pixels, and the minimum object size 430 of a dataset is 128×128 pixels, the object size analysis circuitry 220 can downscale the spatial input resolution by half without any notable accuracy degradation. In some examples, the object size analysis circuitry 220 determines an adjustment of the spatial input size based on an average size of the objects in the input training images. In some examples, the object size analysis circuitry 220 determines the adjustment of the spatial input size based on a minimum size of the objects in the input training images, and a size of a receptive field of the computer vision model.

Example pseudocode which may be used by the object size analysis circuitry 220 to determine an adjusted spatial input size using the algorithm described above is illustrated in Table 2.

```
TABLE 2 [symbol]
(Pseudo code) Object size analysis
object_sizes = [ ]
for data in dataset:
  objects = data.annotation.objects
  for object in objects:
    object_sizes.append(sqrt(object.width * object.height)) [symbol]
If there are object annotations
if len(object_sizes) > [symbol] : [symbol]
  Typical small object size
  min_object_size = max(object_sizes)
  avr_object_size = mean(object_sizes)
  std_object_size = std(object_sizes) [symbol]  standard deviation
  robust_min_object_size = max(min_object_size, avr_object_size [symbol]
3*std_object_size) [symbol]
  Adjust input size by min_object_size
  input_size = input_size * config.receptive_field_size /
robust min object size [symbol]
indicates data missing or illegible when filed
```

Returning to FIG. 2, the input size adjustment circuitry 230 included in the input dimension control circuitry 105 further adjusts the adjusted spatial input size determined by the object size analysis circuitry 220 to produce the final input spatial size to be used to train the computer vision model. In the illustrated example, the input size adjustment circuitry 230 maps the adjusted spatial input size to one of a set of available preset spatial sizes that can be configured for training the computer vision model implemented by the model circuitry 155. For large input size, the input size adjustment circuitry 230 selects a large preset size to allow the model to capture more details but a large preset size requires more computation resources. A smaller preset size may sacrifice some details but are computationally more efficient. In some examples, the input size adjustment circuitry 230 can restrict the spatial input size to adjustments that cause a size reduction relative to the sizes of the training images (e.g., to prevent enlarging the training image sizes for efficiency-oriented applications).

Example pseudocode which may be used by the input size analysis circuitry 230 to determine the final adjustment size using the algorithm described above is illustrated in Table 3.

TABLE 3

[symbol]

(Pseudo code) Final adjustment
preset sizes = [32, 64, 128, 224, 384, 512, 640, 768, 1024]
abs_diff = abs(preset_sizes − input_size)
input_size = preset_sizes[argmin(abs_diff)] [symbol]
Optionally, allow downscale only for efficiancy
if config.down_scale_only:
input_size = min(input_size, config.default_input_size) [symbol]
indicates data missing or illegible when filed

Returning to the illustrated example of FIG. 1, the batch size adaptation circuitry 115 of the input dimension control circuitry 105 adapts a batch size to be used to train the computer vision model implemented by the model circuitry 155. FIG. 5 illustrates an example operation of the batch size adaptation circuitry 115 included in the input dimension control circuitry 105. The batch size (N) 530 is determined according to the spatial input dimensions and the available system resources by modeling the GPU memory usage as a function of batch size, N. In the illustrated example, given a dataset with height, H 510, width, W 520, and batch N, 530, the batch size adaptation circuitry 115 adapts the batch size based on the spatial input size determined by the spatial size adaptation circuitry 110 and system limit (e.g., GPU memory). In the example of FIG. 5, the input dimension (e.g., height and width) is reduced in half, effectively reducing the resolution of the input images, which decreases the computational requirements during training. With the reduction in spatial image size, the batch size adaptation circuitry 115 can increase the batch size 540 (e.g., N×4) without exceeding GPU memory constraints. Increasing the batch size allows more images to be processed simultaneously during each training operation, which improves the efficiency of the training pipeline 125 (FIG. 1).

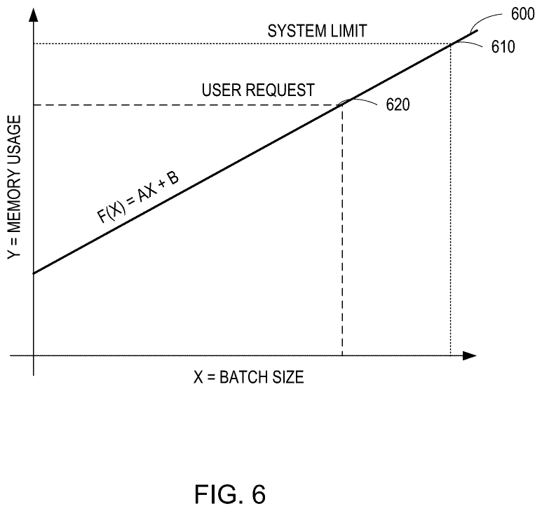

FIG. 6 illustrates an example batch size estimation linear model utilized by the batch size adaptation circuitry 115. In the illustrated example, the batch size adaptation circuitry 115 automatically estimates a batch size to be used for model training by modelling GPU memory consumption, Y as a linear function of batch size, X. In the example of FIG. 6, the y-axis represents GPU memory usage during model training, and the x-axis represents the batch size. The line graph 600 illustrates the linear function is f(x)=ax+b, where f(x) is the memory usage and x is the batch size. In this example model, the parameter “a” captures the spatial input dimension changes and the parameter “b” captures a minimum constant memory overhead, which is not related to the input size and batch size. The system limit 610 represents the GPU memory constraints of the GPU model circuitry 155. The user request 620 represents a current estimated batch size determined by the batch size adaptation circuitry 115. If the batch size adaptation circuitry 115 selects a batch size on the left end of the line graph 600, the memory usage, f(x) is lower than if the batch size adaptation circuitry 115 selects a batch size on the right end of the linear graph 600. The line graph 600 shows the memory usage, f(x) increases with increase in batch sizes, x.

When the current estimated batch size consumes more than the available system memory, the GPU model circuitry 155 returns an out-of-memory (OOM) error, and the batch size adaptation circuitry 115 reduces its estimated batch size to increase the memory margin. On the other hand, if the current estimated batch size shows low memory usage, then the batch size adaptation circuitry 115 can increase the estimated batch size based on this information. When estimating the batch size, a bigger batch size can be more informative because each update to the model's parameters is based on more data points.

Example pseudocode that can be used by the batch size adaptation circuitry 115 to determine the batch size using the linear coefficients described above is illustrated in Table 4.

```
TABLE 4 [symbol]
  Estimate the linear coefficients. [symbol]  two biggest batch size simulated so
far.
  a = (y1 − y2) / (x1 − x2)
  b = y1 − a*x1 [symbol]
  Estimate the right batch size
  batch size = int((max memory − b) / a) [symbol]
indicates data missing or illegible when filed
```

Returning to FIG. 1, the resized image cache circuitry 120 of the input dimension control circuitry 105 caches the training images that are preprocessed or resized by the preprocessor circuitry 150. The resized images are cached for subsequent retrieval to train the computer vision model. Caching resized images saves time as a batch of training images that has been preprocessed, resized and annotated does not have to repeat the preprocessing operation, thus reducing the computation load of the CPU during the preprocessing operation. The resized image cache circuitry 120 hashes the input training images and assigns an identifier to identify the batches of images. In a subsequent training epoch, the resized image cache circuitry 120 checks if the identifier shows up in the cache, to see if the image was preprocessed. If the hash identifier is in the cache of the resized image cache circuitry 120, the resized image cache circuitry 120 retrieves the previously preprocessed image and does not repeat the preprocessing operation, thus saving memory bandwidth in the CPU preprocessing operation. This frees up memory bandwidth for other tasks such as GPU model training. The resized image cache circuitry 120 caches the resized training images based on a unique key and hash value. Hash tables are used to configure the cache systems. The resized image cache circuitry 120 assigns a hash value (e.g., identifier) to each resized image as a unique key. By using hash values as keys, data (e.g., resized images) can be quickly retrieved from cache memory, improving overall training performance. This resized image cache circuitry 120 uses the unique key to look up the corresponding resized image in the cache.

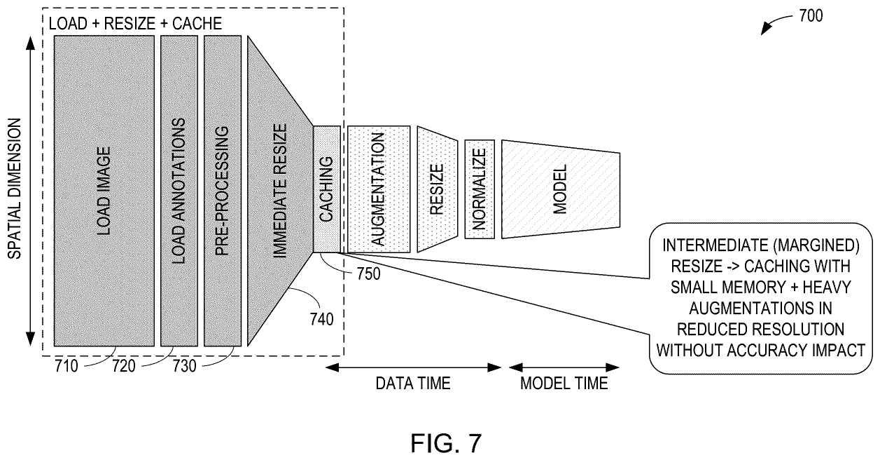

FIG. 7 illustrates further details concerning implementation and operation of the resized image cache circuitry 120. In the illustrated example at operation 710, image data is loaded in the training model pipeline 125 (FIG. 1) by example sampler circuitry 145. At operation 720, the spatial size adaptation circuitry 110 and the batch size adaptation circuitry 115 load annotations (e.g., ground truth data such as bounding boxes, labels, etc. in the training data) to the training pipeline 125. At operation 730, the CPU data pipeline 135 preprocesses an input training image. At operation 740, the preprocessor circuitry 150 outputs a resized intermediate image (e.g., with reduced resolution relative to the original training image size) based on the spatial size determined by the spatial size adaptation circuitry 110. At operation 750, the resized image cache circuitry 120 caches the resized image with a unique key (e.g., hash identifier). The unique key is used by the resized image cache circuitry 120 to retrieve the resized image if the preprocessed image is included in a subsequent training batch.

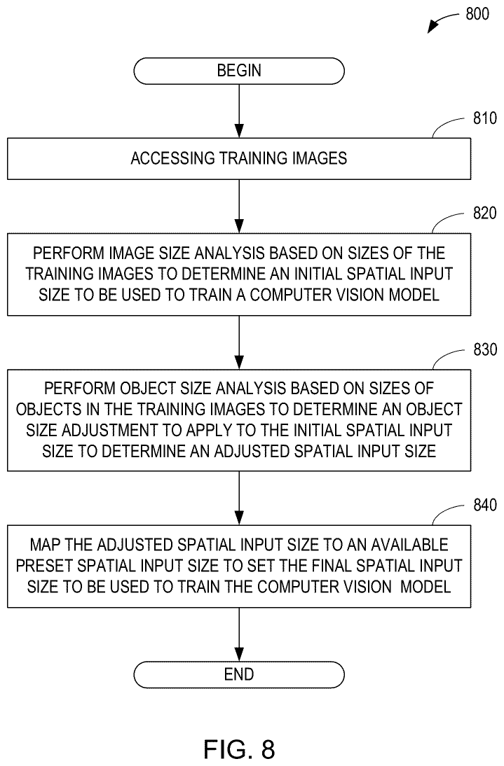

In some examples, the input dimension control circuitry 105 is instantiated by programmable circuitry executing input dimension control circuitry instructions and/or configured to perform operations such as those represented by the flowchart(s) of FIGS. 8-10.

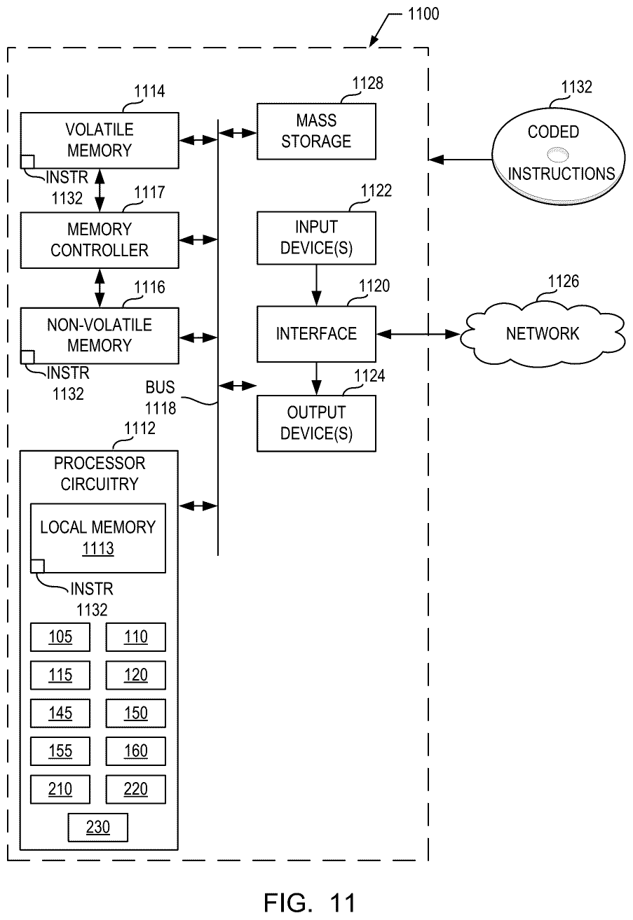

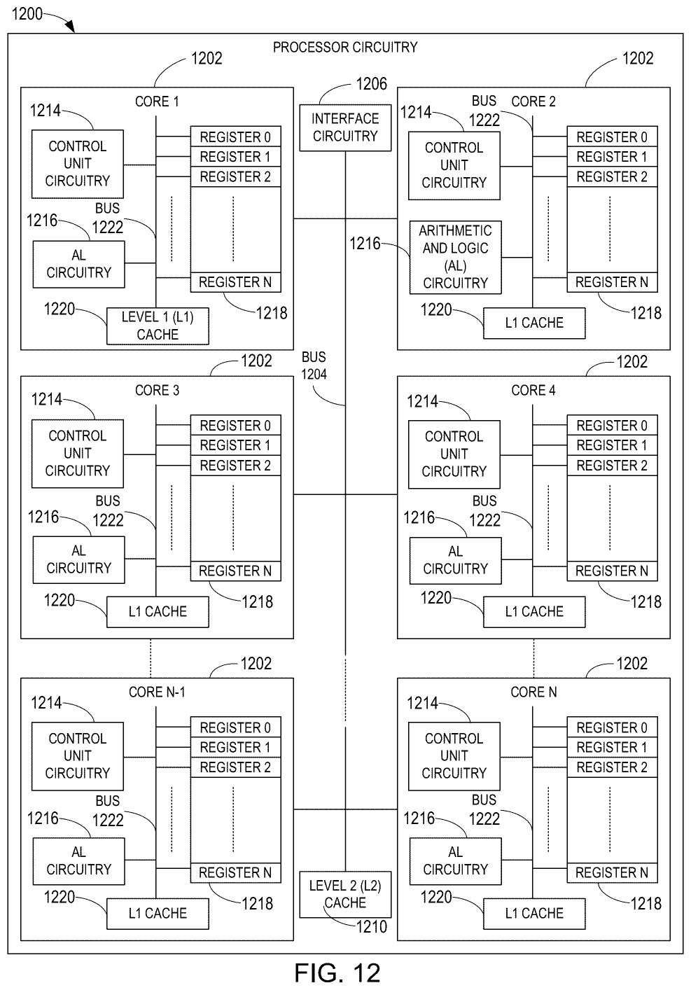

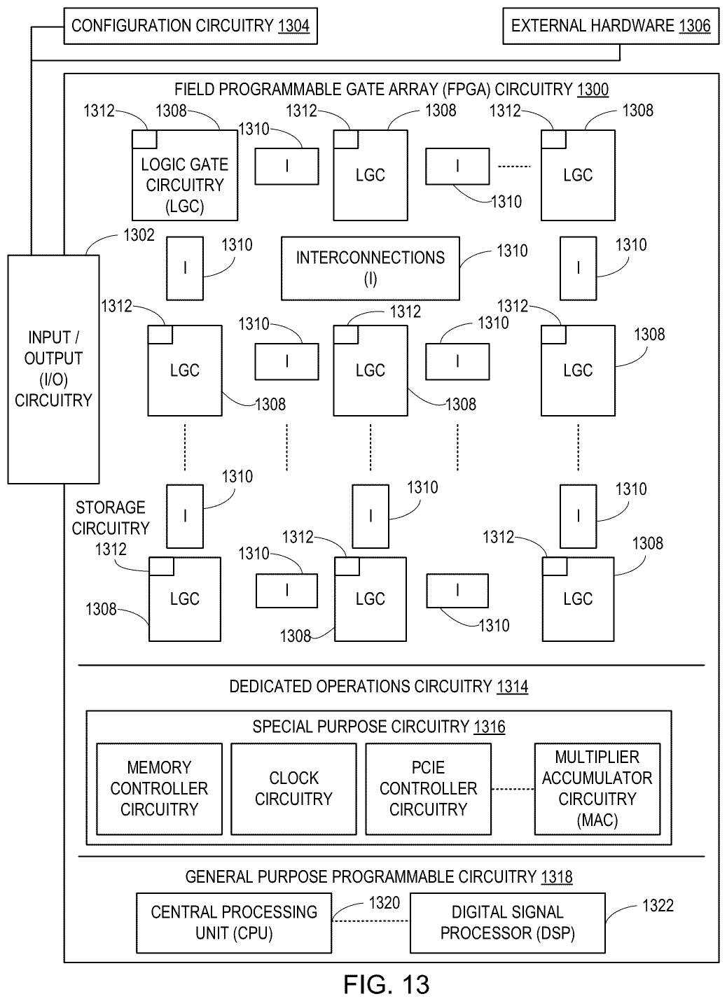

In some examples, the input dimension control circuitry 105 includes means for determining an initial spatial input size. For example, the means for determining the initial spatial input size may be implemented by spatial size analysis circuitry 210. In some examples, the spatial size analysis circuitry 210 may be instantiated by programmable circuitry such as the example programmable circuitry 1112 of FIG. 11. For instance, the spatial size analysis circuitry 210 may be instantiated by the example microprocessor 1200 of FIG. 12 executing machine executable instructions such as those implemented by at least blocks 820 of FIG. 8. In some examples, the spatial size analysis circuitry 210 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the spatial size analysis circuitry 210 may be instantiated by any other combination of hardware, software, and/or firmware. For example, the spatial size analysis circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the input dimension control circuitry 105 includes means for applying an adjustment to the initial spatial input size. For example, the means for applying the adjustment may be implemented by object size analysis circuitry 220. In some examples, object size analysis circuitry 220 may be instantiated by programmable circuitry such as the example programmable circuitry 1112 of FIG. 11. For instance, the object size analysis circuitry 220 may be instantiated by the example microprocessor 1200 of FIG. 12 executing machine executable instructions such as those implemented by at least blocks 830 of FIG. 8. In some examples, the object size analysis circuitry 220 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the object size analysis circuitry 220 may be instantiated by any other combination of hardware, software, and/or firmware. For example, the object size analysis circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the input dimension control circuitry 105 includes means for mapping the adjusted spatial input size to one of a set of available spatial input sizes. For example, the means for mapping the adjusted spatial input size may be implemented by input size adjustment circuitry 230. In some examples, the input size adjustment circuitry 230 may be instantiated by programmable circuitry such as the example programmable circuitry 1112 of FIG. 11. For instance, the input size adjustment circuitry 230 may be instantiated by the example microprocessor 1200 of FIG. 12 executing machine executable instructions such as those implemented by at least blocks 840 of FIG. 8. In some examples, the input size adjustment circuitry 230 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the input size adjustment circuitry 230 may be instantiated by any other combination of hardware, software, and/or firmware. For example, the input size adjustment circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

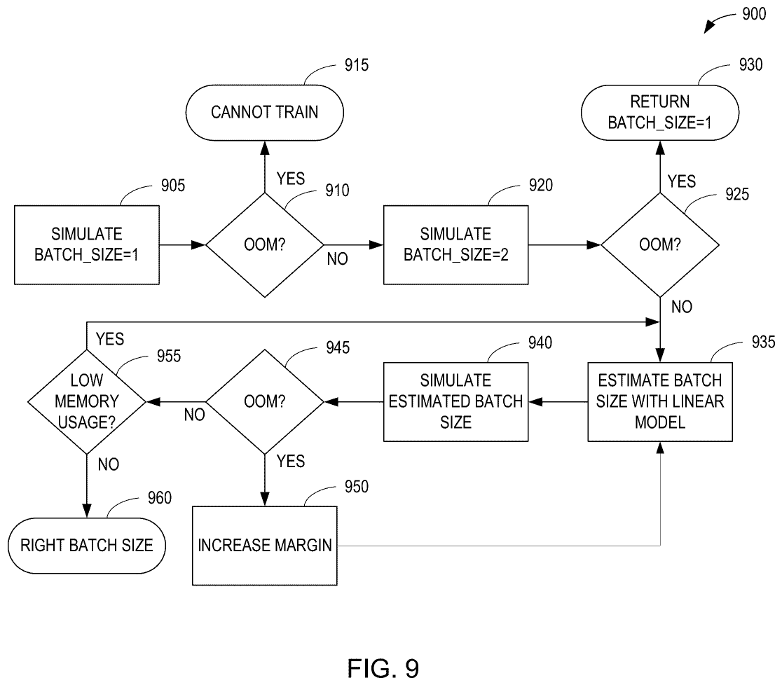

In some examples, the input dimension control circuitry 105 includes means for determining a batch size. For example, the means for determining a batch size may be implemented by batch size adaptation circuitry 115. In some examples, the batch size adaptation circuitry 115 may be instantiated by programmable circuitry such as the example programmable circuitry 1112 of FIG. 11. For instance, the batch size adaptation circuitry 115 may be instantiated by the example microprocessor 1200 of FIG. 12 executing machine executable instructions such as those implemented by at least blocks 905-955 of FIG. 9. In some examples, the batch size adaptation circuitry 115 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the batch size adaptation circuitry 115 may be instantiated by any other combination of hardware, software, and/or firmware. For example, the batch size adaptation circuitry 115 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

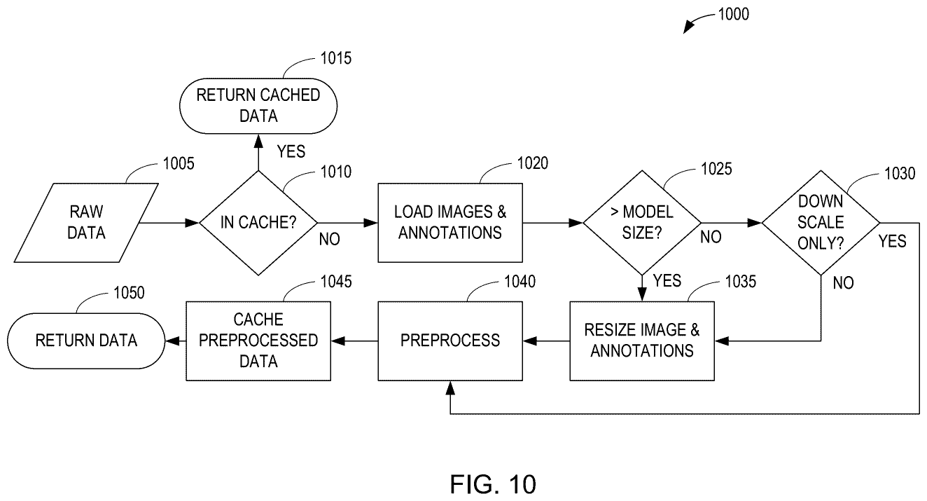

In some examples, the input dimension control circuitry 105 includes means for causing one or more of the input training images to be resized. For example, the means for causing one or more of the input training images to be resized may be implemented by preprocessor circuitry 150. In some examples, the preprocessor circuitry 150 may be instantiated by programmable circuitry such as the example programmable circuitry 1112 of FIG. 11. For instance, the preprocessor circuitry 150 may be instantiated by the example microprocessor 1200 of FIG. 12 executing machine executable instructions such as those implemented by at least blocks 1035 of FIG. 10. In some examples, the preprocessor circuitry 150 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the preprocessor circuitry 150 may be instantiated by any other combination of hardware, software, and/or firmware. For example, the preprocessor circuitry 150 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the input dimension control circuitry 105 includes means for hashing and caching the resized training images. For example, the means for hashing and caching the resized training images may be implemented by resized image cache circuitry 120. In some examples, the resized image cache circuitry 120 may be instantiated by programmable circuitry such as the example programmable circuitry 1112 of FIG. 11. For instance, the resized image cache circuitry 120 may be instantiated by the example microprocessor 1200 of FIG. 12 executing machine executable instructions such as those implemented by at least blocks 1010, 1015, 1045 of FIG. 10. In some examples, the resized image cache circuitry 120 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the resized image cache circuitry 120 may be instantiated by any other combination of hardware, software, and/or firmware. For example, the resized image cache circuitry 120 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the input dimension control circuitry 105 of FIG. 1 is illustrated in FIG. 1, one or more of the elements, processes, and/or devices illustrated in FIG. 1 may be combined, divided, re-arranged, omitted, eliminated, and/or implemented in any other way. Further, the example spatial size adaptation circuitry 110, the example batch size adaptation circuitry 115, the example resized image cache circuitry 120, the example spatial size analysis circuitry 210, the example object size analysis circuitry 220, the example input size adjustment circuitry 230, and/or, more generally, the example input dimension control circuitry 105 of FIG. 1, may be implemented by hardware alone or by hardware in combination with software and/or firmware. Thus, for example, any of the example spatial size adaptation circuitry 110, the example batch size adaptation circuitry 115, the example resized image cache circuitry 120, the example spatial size analysis circuitry 210, the example object size analysis circuitry 220, the example input size adjustment circuitry 230, and/or, more generally, the example input dimension control circuitry 105, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example input dimension control circuitry 105 of FIG. 1 may include one or more elements, processes, and/or devices in addition to, or instead of, those illustrated in FIG. 1, and/or may include more than one of any or all of the illustrated elements, processes and devices.

Flowchart(s) representative of example machine readable instructions, which may be executed by programmable circuitry to implement and/or instantiate the input dimension control circuitry 105 of FIG. 1 and/or representative of example operations which may be performed by programmable circuitry to implement and/or instantiate the input dimension control circuitry 105 of FIG. 1, are shown in FIGS. 8-10. The machine readable instructions may be one or more executable programs or portion(s) of one or more executable programs for execution by programmable circuitry such as the programmable circuitry 1112 shown in the example processor platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 8-10, many other methods of implementing the example input dimension control circuitry 105 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc.

For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 8-10 may be implemented using executable instructions (e.g., computer readable and/or machine readable instructions) stored on one or more non-transitory computer readable and/or machine readable media. As used herein, the terms non-transitory computer readable medium, non- transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 8 is a flowchart representative of example machine readable instructions and/or example operations 800 that may be executed, instantiated, and/or performed by programmable circuitry to automatically adapt spatial input dimensions for computer vision model training based on the training dataset and system resources. The example machine- readable instructions and/or the example operations 800 of FIG. 8 begin at block 810, at which the input dimension control circuitry 105 accesses the training images. The spatial size analysis circuitry 210 performs image size analysis based on sizes of the training images (e.g., height and width) to determine an initial spatial input size to be used to train a computer vision model (block 820). The object size analysis circuitry 220 performs object size analysis based on sizes of objects in the training images to determine an object size adjustment to apply to the initial spatial input size to determine an adjusted spatial input size (block 830). The input size adjustment circuitry 230 maps the adjusted spatial input size to an available preset spatial input size to set the final spatial input size to be used to train the computer vision model (block 840). The preset spatial input size is discussed above in connection with FIG. 2. The example instructions and/or operations 800 of FIG. 8 end.

FIG. 9 is a flowchart representative of example machine readable instructions and/or example operations 900 that may be executed, instantiated, and/or performed by programmable circuitry to automatically estimate a training batch size by modeling the memory consumption as a linear function of batch size. The example machine-readable instructions and/or the example operations 900 of FIG. 9 begin at block 905, at which the batch size adaptation circuitry 115 simulates the training pipeline 125 (FIG. 1) with respect to a batch size of 1 training image by running one iteration and determining the peak memory usage of that iteration. The batch size adaptation circuitry 115 determines if the selected batch size of 1 image causes an out-of-memory (OOM) error (block 910). If the batch size of 1 image causes an OOM error (block 910: YES), the batch size adaptation circuitry 115 determines that the model cannot be trained (block 915).

However, if the batch size adaptation circuitry 115 determines that the batch size of 1 image does not cause an OOM error (block 910: NO), the batch size adaptation circuitry 115 simulates the training pipeline with a batch size of 2 images (block 920). The batch size adaptation circuitry 115 determines if the batch size of 2 images causes out-of-memory (OOM) error (block 925). If the batch size of 2 images causes an OOM error (block 925: YES), the batch size adaptation circuitry 115 returns batch size of 1 image as the batch size to be used to train the computer vision model (block 930).

However, if the batch size adaptation circuitry 115 determines that the batch size of 2 images does not cause an OOM error (block 925: NO), the batch size adaptation circuitry 115 estimates another candidate batch size with a linear model (block 935). The simulation results from the previously simulated batch sizes and their corresponding memory consumptions are used by the batch size adaptation circuitry 115 to estimate a linear model for the batch size. The batch size adaptation circuitry 115 simulates the training pipeline with the estimated batch size (block 940). The batch size adaptation circuitry 115 determines if the estimated batch size causes an OOM error (block 945). If the estimated batch size causes an OOM error (block 945: YES), the batch size adaptation circuitry 115 reduces the batch size to increase the memory usage margin (block 950), and the control returns to block 935. Using the linear model as described above in connection with FIG. 6, if the final estimated batch size does not cause an OOM error (block 945: NO), the batch size adaptation circuitry 115 determines if there is low memory usage (block 950). If there is low memory usage (block 950: YES), control returns to block 935. If there is no low memory usage (block 950: NO), the batch size adaptation circuitry 115 outputs the current estimated batch size is batch size to be used for model training (block 955). The example instructions and/or operations 900 of FIG. 9 end.

FIG. 10 is a flowchart representative of example machine readable instructions and/or example operations 1000 that may be executed, instantiated, and/or performed by programmable circuitry to cache the resized image. The example machine-readable instructions and/or the example operations 1000 of FIG. 10 begin at block 1005, at which the training data is loaded to the training pipeline 125. The resized image cache circuitry 120 determines whether the data is in the cache storage (block 1010). If the resized image cache circuitry 120 determines that the data is in the cache (block 1010: YES), the resized image cache circuitry 120 returns the cached data (block 1015). If the resized image cache circuitry 120 determines that the data is not in the cache (block 1010: NO), the CPU data pipeline 135 loads the input image and annotations (e.g., spatial input size and batch size) (block 1020). The spatial size adaptation circuitry 110 checks whether the original training image size and annotations is greater than the spatial input size determined by the spatial size adaptation circuitry 110 (block 1025). If the training image sizes and annotations are not greater than the spatial input size (block 1025: NO), the spatial size adaptation circuitry 110 determines whether to limit images resizing to downscaling the input dimension for efficiency (block 1030). If the spatial size adaptation circuitry 110 determines that resizing is limited to downscaling for efficiency, control proceeds to block 1040. Otherwise, the preprocessor circuitry 150 resizes the input image and applies the annotations (block 1035).

If the training image sizes and annotations are greater than the spatial input size (block 1025: YES), the preprocessor circuitry 150 resizes the training images and annotations (block 1035). Resizing the annotations means resizing the bounding boxes, relocating labels (e.g., resizing cause locations of objects to change), etc. The preprocessor circuitry 150 preprocesses the (resized) input training image (block 1040). The resized image cache circuitry 120 caches the preprocessed data (e.g., resized image) with its unique identifier or key (block 1045). The resized image cache circuitry 120 returns cached data to the training pipeline when requested (block 1050). The example instructions and/or operations 1000 of FIG. 10 end.

FIG. 11 is a block diagram of an example programmable circuitry platform 1100 structured to execute and/or instantiate the example machine-readable instructions and/or the example operations of FIGS. 8-10 to implement the input dimension control circuitry 105 of FIG. 1. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the example spatial size adaptation circuitry 110, the example batch size adaptation circuitry 115, the example resized image cache circuitry 120, the example spatial size analysis circuitry 210, the example object size analysis circuitry 220, the example input size adjustment circuitry 230, and/or, more generally, the example input dimension control circuitry 105.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated examples is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1132, which may be implemented by the machine readable instructions of FIGS. 8-10, may be stored in the mass storage device 1128, in the volatile memory 1114, in the non-volatile memory 1116, and/or on at least one non- transitory computer readable storage medium such as a CD or DVD which may be removable.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 8-10 to effectively instantiate the circuitry of FIG. 2 as logic circuits to perform operations corresponding to those machine readable instructions. In some such examples, the circuitry of FIG. 1 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 8-10.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine readable instructions represented by the flowchart(s) of FIGS. 8-10 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 8-10. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 8-10. As such, the FPGA circuitry 1300 may be configured and/or structured to effectively instantiate some or all of the operations/functions corresponding to the machine readable instructions of the flowchart(s) of FIGS. 8-10 as dedicated logic circuits to perform the operations/functions corresponding to those software instructions in a dedicated manner analogous to an ASIC. Therefore, the FPGA circuitry 1300 may perform the operations/functions corresponding to some or all of the machine readable instructions of FIGS. 8-10 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine readable instructions of FIGS. 8-10 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine readable instructions represented by the flowchart(s) of FIGS. 8-10 to perform first operation(s)/function(s), the FPGA circuitry 1300 of FIG. 13 may be configured and/or structured to perform second operation(s)/function(s) corresponding to a second portion of the machine readable instructions represented by the flowcharts of FIG. 8-10, and/or an ASIC may be configured and/or structured to perform third operation(s)/function(s) corresponding to a third portion of the machine readable instructions represented by the flowcharts of FIGS. 8-10.

It should be understood that some or all of the circuitry of FIG. 1 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 1200 of FIG. 12 may execute machine readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIG. 1 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

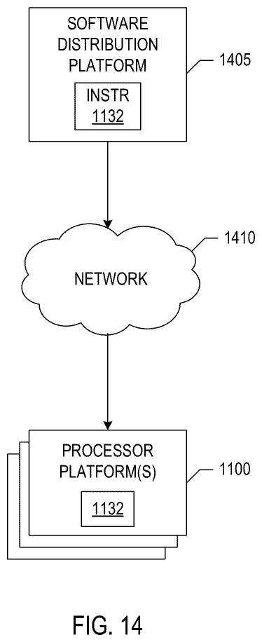

A block diagram illustrating an example software distribution platform 1405 to distribute software such as the example machine readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions of FIGS. 8-10, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions of FIG. 8-10, may be downloaded to the example programmable circuitry platform 1100, which is to execute the machine readable instructions 1132 to implement the input dimension control circuitry 105. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that automatically adapt the input dimensions for computer vision model training based on the training dataset and system resources to customize the training to the particular computer vision use case. Disclosed systems, apparatus, articles of manufacture, and methods improve the efficiency of using a computing device by analyzing input dimensions of input images and adjusting the spatial input size or spatial resolution for computer vision model training. Adjusting batch size based on user's dataset and available GPU memory in the training pipeline. Caching resized or processed input images to avoid re-processing the same input image and thus minimizing computer overhead. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to control input dimensions for computer vision model training are disclosed herein. Further examples and combinations thereof include the following.

Example 1 includes an apparatus comprising interface circuitry, computer readable instructions, and at least one processor circuit to be programmed by the computer readable instructions to determine an initial spatial input size to be used to train a computer vision model, the initial spatial input size based on sizes of input training images, apply an adjustment to the initial spatial input size to determine an adjusted spatial input size, the adjustment based on sizes of objects in the input training images, and map the adjusted spatial input size to one of a set of available spatial input sizes to determine a final spatial input size to be used to train the computer vision model.

Example 2 includes the apparatus of example 1, wherein one or more of the at least one processor circuit is to determine the initial spatial input size based on an average size of the input training images.

Example 3 includes the apparatus of example 2, wherein one or more of the at least one processor circuit is to determine the initial spatial input size based on the average size of the input training images, a standard deviation of the sizes of the input training images and a maximum size of the input training images.

Example 4 includes the apparatus of example 1, wherein one or more of the at least one processor circuit is to determine the adjustment based on an average size of the objects in the input training images, a standard deviation of the sizes of the objects in the input training images, a minimum size of the objects in the input training images, and a size of a receptive field of the computer vision model.

Example 5 includes the apparatus of example 1, wherein one or more of the at least one processor circuit is to evaluate a linear model to determine a final batch size to be used to train the computer vision model, the linear model based on a first simulation of training the computer vision model and a second simulation of training the computer vision model, the first simulation based on the final spatial input size and a first batch size, the second simulation based on the final spatial input size and a second batch size different from the first batch size.

Example 6 includes the apparatus of example 1, wherein one or more of the at least one processor circuit is to cause the one or more of the input training images to be resized to have the final spatial input size and cache the resized training images for subsequent retrieval to train the computer vision model.

Example 7 includes the apparatus of example 6, wherein the one or more of the at least one processor circuit is to hash ones of the input training images to determine respective identifiers to be used to identify corresponding ones of the resized training images and cause the respective identifiers to be cached with the corresponding ones of the resized training images.

Example 8 includes At least one non-transitory machine-readable medium comprising machine-readable instructions to cause at least one processor circuit to at least determine an initial spatial input size to be used to train a computer vision model, the initial spatial input size based on sizes of input training images, apply an adjustment to the initial spatial input size to determine an adjusted spatial input size, the adjustment based on sizes of objects in the input training images, and map the adjusted spatial input size to one of a set of available spatial input sizes to determine a final spatial input size to be used to train the computer vision model.

Example 9 includes the at least one non-transitory machine-readable medium of example 8, wherein the machine-readable instructions are to cause one or more of the at least one processor circuit to determine the initial spatial input size based on an average size of the input training images.

Example 10 includes the at least one non-transitory machine-readable medium of example 9, wherein the machine-readable instructions are to cause one or more of the at least one processor circuit to determine the initial spatial input size based on the average size of the input training images, a standard deviation of the sizes of the input training images and a maximum size of the input training images.

Example 11 includes the at least one non-transitory machine-readable medium of example 8, wherein the machine-readable instructions are to cause one or more of the at least one processor circuit to determine the adjustment based on an average size of the objects in the input training images, a standard deviation of the sizes of the objects in the input training images, a minimum size of the objects in the input training images, and a size of a receptive field of the computer vision model.

Example 12 includes the at least one non-transitory machine-readable medium of example 8, wherein the machine-readable instructions are to cause one or more of the at least one processor circuit to evaluate a linear model to determine a final batch size to be used to train the computer vision model, the linear model based on a first simulation of training the computer vision model and a second simulation of training the computer vision model, the first simulation based on the final spatial input size and a first batch size, the second simulation based on the final spatial input size and a second batch size different from the first batch size.

Example 13 includes the at least one non-transitory machine-readable medium of example 8, wherein the machine-readable instructions are to cause one or more of the at least one processor circuit to cause the one or more of the input training images to be resized to have the final spatial input size and cache the resized training images for subsequent retrieval to train the computer vision model.

Example 14 includes the at least one non-transitory machine-readable medium of example 13, wherein the machine-readable instructions are to cause one or more of the at least one processor circuit to hash ones of the input training images to determine respective identifiers to be used to identify corresponding ones of the resized training images and cause the respective identifiers to be cached with the corresponding ones of the resized training images.

Example 15 includes a method comprising determining, by at least one processor circuit programmed by at least one instruction, an initial spatial input size to be used to train a computer vision model, the initial spatial input size based on sizes of input training images, applying, by one or more of the at least one processor circuit, an adjustment to the initial spatial input size to determine an adjusted spatial input size, the adjustment based on sizes of objects in the input training images, and mapping the adjusted spatial input size to one of a set of available spatial input sizes to determine a final spatial input size to be used to train the computer vision model.

Example 16 includes the method of example 15, further including determining the initial spatial input size based on an average size of the input training images.

Example 17 includes the method of example 16, further including determining the initial spatial input size based on the average size of the input training images, a standard deviation of the sizes of the input training images and a maximum size of the input training images.

Example 18 includes the method of example 15, further including determining the adjustment based on an average size of the objects in the input training images, a standard deviation of the sizes of the objects in the input training images, a minimum size of the objects in the input training images, and a size of a receptive field of the computer vision model.

Example 19 includes the method of example 15, further including evaluating a linear model to determine a final batch size to be used to train the computer vision model, the linear model based on a first simulation of training the computer vision model and a second simulation of training the computer vision model, the first simulation based on the final spatial input size and a first batch size, the second simulation based on the final spatial input size and a second batch size different from the first batch size.

Example 20 includes the method of example 15, further including causing the one or more of the input training images to be resized to have the final spatial input size and caching the resized training images for subsequent retrieval to train the computer vision model.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
computer readable instructions; and
at least one processor circuit to be programmed by the computer readable instructions to:
determine an initial spatial input size to be used to train a computer vision model, the initial spatial input size based on sizes of input training images;
apply an adjustment to the initial spatial input size to determine an adjusted spatial input size, the adjustment based on sizes of objects in the input training images; and
map the adjusted spatial input size to one of a set of available spatial input sizes to determine a final spatial input size to be used to train the computer vision model.

2. The apparatus of claim 1, wherein one or more of the at least one processor circuit is to determine the initial spatial input size based on an average size of the input training images.

3. The apparatus of claim 2, wherein one or more of the at least one processor circuit is to determine the initial spatial input size based on the average size of the input training images, a standard deviation of the sizes of the input training images and a maximum size of the input training images.

4. The apparatus of claim 1, wherein one or more of the at least one processor circuit is to determine the adjustment based on an average size of the objects in the input training images, a standard deviation of the sizes of the objects in the input training images, a minimum size of the objects in the input training images, and a size of a receptive field of the computer vision model.

5. The apparatus of claim 1, wherein one or more of the at least one processor circuit is to evaluate a linear model to determine a final batch size to be used to train the computer vision model, the linear model based on a first simulation of training the computer vision model and a second simulation of training the computer vision model, the first simulation based on the final spatial input size and a first batch size, the second simulation based on the final spatial input size and a second batch size different from the first batch size.

6. The apparatus of claim 1, wherein one or more of the at least one processor circuit is to:
cause the one or more of the input training images to be resized to have the final spatial input size; and
cache the resized training images for subsequent retrieval to train the computer vision model.

7. The apparatus of claim 6, wherein the one or more of the at least one processor circuit is to:
hash ones of the input training images to determine respective identifiers to be used to identify corresponding ones of the resized training images; and
cause the respective identifiers to be cached with the corresponding ones of the resized training images.

8. At least one non-transitory machine-readable medium comprising machine-readable instructions to cause at least one processor circuit to at least:
determine an initial spatial input size to be used to train a computer vision model, the initial spatial input size based on sizes of input training images;
apply an adjustment to the initial spatial input size to determine an adjusted spatial input size, the adjustment based on sizes of objects in the input training images; and
map the adjusted spatial input size to one of a set of available spatial input sizes to determine a final spatial input size to be used to train the computer vision model.

9. The at least one non-transitory machine-readable medium of claim 8, wherein the machine-readable instructions are to cause one or more of the at least one processor circuit to determine the initial spatial input size based on an average size of the input training images.

10. The at least one non-transitory machine-readable medium of claim 9, wherein the machine-readable instructions are to cause one or more of the at least one processor circuit to determine the initial spatial input size based on the average size of the input training images, a standard deviation of the sizes of the input training images and a maximum size of the input training images.

11. The at least one non-transitory machine-readable medium of claim 8, wherein the machine-readable instructions are to cause one or more of the at least one processor circuit to determine the adjustment based on an average size of the objects in the input training images, a standard deviation of the sizes of the objects in the input training images, a minimum size of the objects in the input training images, and a size of a receptive field of the computer vision model.

12. The at least one non-transitory machine-readable medium of claim 8, wherein the machine-readable instructions are to cause one or more of the at least one processor circuit to evaluate a linear model to determine a final batch size to be used to train the computer vision model, the linear model based on a first simulation of training the computer vision model and a second simulation of training the computer vision model, the first simulation based on the final spatial input size and a first batch size, the second simulation based on the final spatial input size and a second batch size different from the first batch size.

13. The at least one non-transitory machine-readable medium of claim 8, wherein the machine-readable instructions are to cause one or more of the at least one processor circuit to:
cause the one or more of the input training images to be resized to have the final spatial input size; and
cache the resized training images for subsequent retrieval to train the computer vision model.

14. The at least one non-transitory machine-readable medium of claim 13, wherein the machine-readable instructions are to cause one or more of the at least one processor circuit to:
hash ones of the input training images to determine respective identifiers to be used to identify corresponding ones of the resized training images; and
cause the respective identifiers to be cached with the corresponding ones of the resized training images.

15. A method comprising:
determining, by at least one processor circuit programmed by at least one instruction, an initial spatial input size to be used to train a computer vision model, the initial spatial input size based on sizes of input training images;
applying, by one or more of the at least one processor circuit, an adjustment to the initial spatial input size to determine an adjusted spatial input size, the adjustment based on sizes of objects in the input training images; and
mapping the adjusted spatial input size to one of a set of available spatial input sizes to determine a final spatial input size to be used to train the computer vision model.

16. The method of claim 15, further including determining the initial spatial input size based on an average size of the input training images.

17. The method of claim 16, further including determining the initial spatial input size based on the average size of the input training images, a standard deviation of the sizes of the input training images and a maximum size of the input training images.

18. The method of claim 15, further including determining the adjustment based on an average size of the objects in the input training images, a standard deviation of the sizes of the objects in the input training images, a minimum size of the objects in the input training images, and a size of a receptive field of the computer vision model.

19. The method of claim 15, further including evaluating a linear model to determine a final batch size to be used to train the computer vision model, the linear model based on a first simulation of training the computer vision model and a second simulation of training the computer vision model, the first simulation based on the final spatial input size and a first batch size, the second simulation based on the final spatial input size and a second batch size different from the first batch size.

20. The method of claim 15, further including:
causing the one or more of the input training images to be resized to have the final spatial input size; and
caching the resized training images for subsequent retrieval to train the computer vision model.
